(19) United States
(12) Patent Application Publication
(10) Pub. No.: US 2010/0281965 A1
(43) Pub. Date: Nov. 11, 2010

(54) CUTTING TEST DEVICE FOR KNIVES AND OTHER CUTTING TOOLS

(75) Inventor: Dominique Lazime, Clermont-Ferrand (FR)

Correspondence Address: CANTOR COLBURN, LLP, 20 Church Street, 22nd Floor, Hartford, CT, 06103, US

(73) Assignee: ETS JEAN DEGLON, THIERS (FR)

(21) Appl. No.: 12/601,447

(22) PCT Filed: May 15, 2007
(86) PCT No.: PCT/FR2007/000825

§ 371 Date: May 25, 2010

(51) Int. Cl. G01N 3/58

(52) U.S. Cl. 73/104

(57) ABSTRACT

The device of the invention can be used for evaluating the cutting ability of knives and other like cutting tools. The device includes a rigid body (2) with a slide (10) receiving a foam rod (12), and a bearing surface (8) substantially perpendicular to the slide (10) for positioning and guiding the cutting tool (16) to be tested. The foam rod (12) includes two visually discernible portions (13, 14) placed one above the other, and in particular having different colours, and is placed in the slide (10) so as to project from the front of the bearing surface (8). The test comprises cutting the protruding end of the rod (12) by reciprocating (F) the tool (16), and assessing whether the blade (15) has cut only the upper portion (13) or both portions (13, 14) of the rod. The device can be used for testing knives, surgical instruments, farming and gardening tools, industrial cutting tools, etc.

### FIELD OF THE INVENTION

This disclosure relates to a cutting test device, which allows evaluating the cutting ability of knives and other similar cutting tools.

Specifically, the technical field of this disclosure is that of cutting tools such as household or professional knives, surgical tools, tools for agriculture and gardening, cutting tools used in the food and other industries or in any other field that uses cutting tools. The disclosure can be applied not only to testing manual cutting tools, but also to testing cutting tools for mechanized use, for example mounted on an automatic machine.

### BACKGROUND

The user of such a cutting tool always has difficulty to evaluate the cutting ability of his tool. Yet, this cutting ability often needs to be evaluated, either while using the tool or after sharpening the blade edge. Beyond the common use of cutting tools and their maintenance, there is also the need to evaluate the cutting ability during the manufacture of cutting tools.

Currently, in common usage, be it professional or household, the evaluation of the effectiveness of the edge of a cutting tool remains very empirical. Each user has his own method, for example by placing a finger of his hand on the edge in order to perceive or not the presence of a sharp edge, or by performing a test on a variety of products, such as the skin of a tomato, a cucumber, a sheet of paper, etc.

The most rigorous method is described in French standard NF EN ISO 8442-5 (Part 5): “Specification of the edge and edge preservation test.”

This method has the principle of measuring the cutting ability of a blade, serrated or not, using a specific machine. Specifically, the test involves cutting strips of paper with predefined characteristics, using the cutting tool to be tested by performing back and forth movements with determined length and force. To date, this test is the most correct and accurate to

objectively characterize the two magnitudes that are, on the one hand, the original cutting ability and, on the other hand, the preservation of the edge of a cutting tool. Indeed, it provides a true measure of the thickness of the paper cut by the cutting tool being tested for a number of back and forth movements that are always identical.

However, this test method has the disadvantage of being costly and time consuming, requiring bulky equipment, and especially performing a destructive test of the cutting edge of the cutting tool tested. Indeed, after the test, the cutting edge of the cutting tool was destroyed by cutting strips of paper. It is therefore a “laboratory” method unworkable in everyday professional or household use for the practical needs of a user of a cutting tool.

### SUMMARY

This disclosure seeks to avoid all these disadvantages by providing a clean test device to replace the purely empirical methods, enabling any user of a cutting tool to assess, quickly and without damaging it, the cutting ability of an edge, since the device proposed has a simple and economical structure and is compact.

It will be noted that the disclosure is not intended to provide a measuring device giving a numerical result representing the cutting ability, but the purpose of the proposed device is to assess quickly and simply the cutting ability of a cutting tool by conducting a so-called control “by attribute,” i.e. a control that allows concluding, positively or negatively, in other words, finding whether the cutting ability of the tool is “satisfactory” or “unsatisfactory.”

For this purpose, the disclosure relates to a cutting test device for knives and other cutting tools, allowing for the testing of their cutting ability; this cutting test device essentially includes:
on the one hand, a rigid body with a slide and a bearing surface substantially perpendicular to the slide and able to position and guide a cutting tool to be tested,
and on the other hand, at least one foam rod designed to be, in use, placed in the aforementioned slide so as to exceed, at one end at the front of the bearing surface, the foam rod having at least two visually discernible overlapping parts.

Thus, the principle of the disclosure is to present in front of a bearing surface, the end of a foam rod, which is conveniently maintained, and to cut this end by a few back and forth movements of the cutting tool to be tested, guided by said bearing surface. The foam of the rod is chosen to have a density such that its cutting strength is close to that of a product commonly cut by the tool concerned, such as raw meat for a kitchen knife. If during the test, the cutting blade of the tool cuts only the upper part of the foam rod, the cutting ability is considered inadequate. However, if the blade cuts the entire top of the foam rod and starts to cut its lower part, or entirely cuts this lower part, the cutting ability is deemed satisfactory. The housing of the foam rod in a slide of the rigid body conveniently maintains this foam rod during a test, by its non-extending part, and thus allows us to gradually move the foam rod, in order to do successive cutting tests, using the same foam rod.

In a preferred and particularly ergonomic embodiment of the cutting test device, its rigid body has a base forming a sole, a shield extending upward from the base and defining the aforementioned bearing surface, and a handle attached to the shield and extending above the base, the handle having a longitudinal slot which constitutes the slide suitable to receive a foam rod.

To the extent that the foam rod to be received has a square or rectangular section, the slot of the handle has a corresponding square or rectangular section, and the shield advantageously has an opening also with an appropriate section, provided in the extension of the aforementioned slot and allowing the end of the foam rod to extend towards the exterior.

Thus, the base provides, by its sole, stable support of the device on any work surface, especially during a test operation, while the shield, substantially perpendicular to the handle, provides protection for the operator's hand during the test.

Preferably, the base is extended by a stop located at the base of the shield, and able to stop the blade of the cutting tool, if

the rod is fully cut, to avoid hitting and scratching with the tool the work surface on which the device is placed.

The base of the device may also include at least one housing, in the form of a honeycomb, capable of receiving a replacement foam rod.

The foam rod advantageously results from the superposition of a first foam layer, which is the top layer when in use, and a second foam layer, which is the lower layer when in use, the two layers being assembled by bonding at their interface. In a preferred embodiment, these two layers have different thicknesses, the height of the upper foam layer being larger than the height of the lower foam layer of the rod. More specifically, the height of the upper foam layer can substantially represent two thirds of the total thickness of the rod, while the height of the lower foam layer substantially represents one third of the total thickness of the rod.

According to a preferred embodiment, the two layers of foam of the rod are of different colors, for example with a red top layer and a green lower layer, both colors being clearly distinguished by the eye, and having an intuitive meaning of “bad” and “good,” respectively.

Overall, the cutting test device has the advantages of being simple, reliable, quick to use, compact and inexpensive, the device allowing to evaluate fairly objectively the cutting ability of a cutting tool, contrary to the current empirical methods, and also allowing to evaluate the cutting ability without degrading or destroying the cutting edge of the tool, unlike the standard method described above. These advantages are discussed below.

In particular, the device is very simple in its structure, which has no mechanism and no moving mechanical parts, with its body being made of one piece, by machining or molding. The cost of such a device is therefore negligible, and its simple construction is already contributing to its reliability.

The device is small in size and can be easily carried in a pocket or bag, to be taken to the site of

use of the cutting tool it is used to test. The foam rod is also limited in length, e.g. a length of 150 mm being sufficient to have a certain reserve, permitting a significant number of tests using the same rod, without making the whole too cumbersome.

Each cutting test is easily done in a few back and forth movements of the cutting tool, which only takes a few seconds, and a test consumes only a small length of the foam rod. The cost of a test is therefore negligible, both in labor and material.

The gesture to be performed by the operator during the cutting test is, in most cases of application, identical to the usual gesture of the user of the cutting tool, namely an action of pressure combined with back and forth motions of the tool. This back and forth gesture and applying pressure is a universal gesture practiced in every place and by every person in his life. Understanding the modus operandi for the use of the device is therefore easy and immediate. So, overall, the use of the device requires no special technical skills on the part of the operator.

In addition, “reading” the test result and its interpretation are intuitive and immediate, especially in the case of a two-tone foam rod with a red zone and a green zone, which appear one above the other on its edge.

Without changing the rigid part of the device, it is possible to easily adapt it to every type of cutting tool to be tested, choosing the nature and characteristics of the foam constituting the rod. For example, a surgeon will use foam with relatively low mechanical properties to evaluate the cutting ability of the edge of a scalpel, while a woodcutter, to assess the cutting ability of edge of his hatchet, will need a rod made of a foam with significant mechanical performance.

The square or rectangular section of the foam rod not only ensures the correct positioning of the rod in the corresponding slot, but also the constant effort to be exerted during the cutting test.

By its principle and construction, the cutting test device also provides safety to the operator during use, as well as to the immediate environment (protection of the work surface on which the device sits).

The cutting test device has strong educational value and can be used either occasionally or systematically as part of an industrial organization, by all types of users of cutting tools or instruments. Thus, this cutting test device allows not only knowing at any moment the cutting ability of a cutting tool, but also assessing whether a threshold or fixed limit is reached, and therefore knowing the right time for resharpening. It also helps determine whether or not the resharpening of the edge of a tool has been performed properly, by performing a sort of calibration. The cutting test device can thus be used as a means of evaluating the cutting ability of a cutting tool or instrument in the context of commercial contracts, or under contracts to provide sharpening or wear point.

Finally, with the embodiment of its rigid body in a suitable material, the cutting test device can be used in all trades that use cutting tools or instruments, since it can work under various conditions or environment which are sometimes severe: heat, cold, dust, grease, sterile room, “gray” or “white” room. The foam of the rod, being a closed cell foam, is also usable in the same conditions.

The disclosure also concerns, as such, a foam rod having at least two visually discernible overlapping parts, intended for use in a cutting test device as described above.

### BRIEF DESCRIPTION OF THE FIGURES

The disclosure will be better understood from the following description, with reference to the attached schematic drawing representing, by way of example, an embodiment of this cutting test device for knives and other cutting tools:

FIG. 1 is a perspective view of a cutting test device;

FIG. 2 is a front view of the device of FIG. 1;

FIG. 3 is a plan view from above the device;

FIG. 4 is an end view;

FIG. 5 shows, in perspective, a foam rod usable in the device of FIGS. 1 to 4;

FIG. 6 is a perspective view illustrating the use of this device for a cutting test of a knife.

### DETAILED DESCRIPTION

The cutting test device shown in the drawing includes a rigid element 2 shaped like a housing with a hollow base 3, a shield 4 extending upward from one end of the base 3, in a square configuration, and a handle 5 attached to the shield 4 and extending above the base 3 slightly inclined horizontally.

The base 3 comprises three longitudinal housings 6, parallel, in the form of a honeycomb with section substantially square, which lead to the end of this base 3 far from the shield 4. The flat underside of the base 3 forms a sole 7.

The shield 4 defines externally a flat bearing surface 8 substantially vertical. Towards the base of this bearing surface 8, the base 3 is extended by a short stop 9, which thus extends to the base of the shield 4.

The handle 5 comprises a longitudinal slide 10 with square or rectangular section, opened at the top. In line with the slide 10, the shield 4 has an opening 11 with corresponding square or rectangular section.

The device is completed by a foam rod 12, represented only in FIG. 5. The rod 12 with square or rectangular section corresponding to that of the slide 10 is made of two layers of foam 13 and 14 stacked and bonded to each other, of different colors and uneven thickness.

The first foam layer 13, which is the top layer, is for example red. This is the thickest layer, e.g. having for example a height H of 10 mm and a width of 15 mm.

The second foam layer 14, which is the lower layer, is for example green. This is the thinnest layer, e.g. having a height h of 5 mm by a width of 15 mm.

Overall, the foam rod 12, made by assembling the two layers of colored foam 13 and 14, has for example a length of 120 mm by a square section measuring 15×15 mm.

The two constituent layers 13 and 14 of the foam rod 12 can both be manufactured of a closed cell synthetic foam, for example with a density of 30 kg/m3.

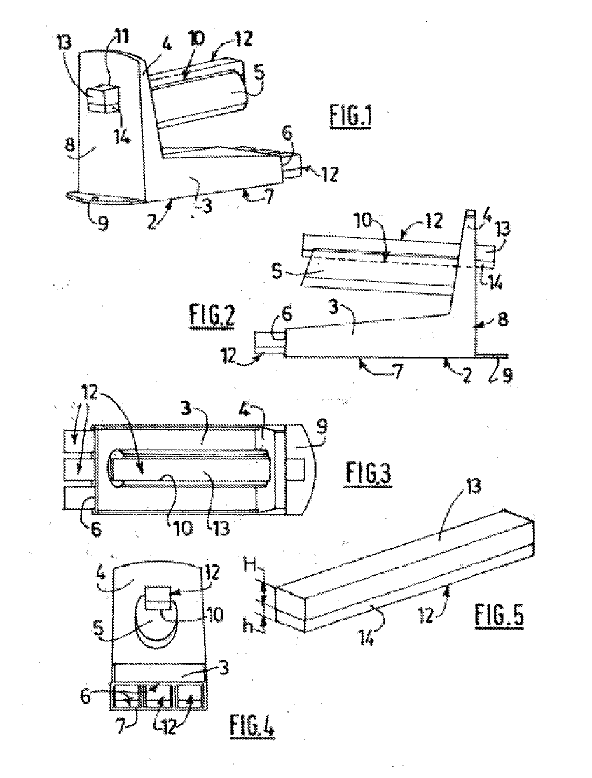

To use the device, this foam rod 12 is slid into the slide 10 of the handle 5, so that one end of this rod 12 crosses through the opening 11 of the shield 4 and slightly projects from the front of this opening 11, and therefore from the front of the bearing surface 8 (see particularly FIGS. 1 and 2).

The longitudinal housings 6 of the base 3 of the box 2 may receive other similar foam rods 12, which are replacement rods, thus providing a degree of autonomy to the device when used.

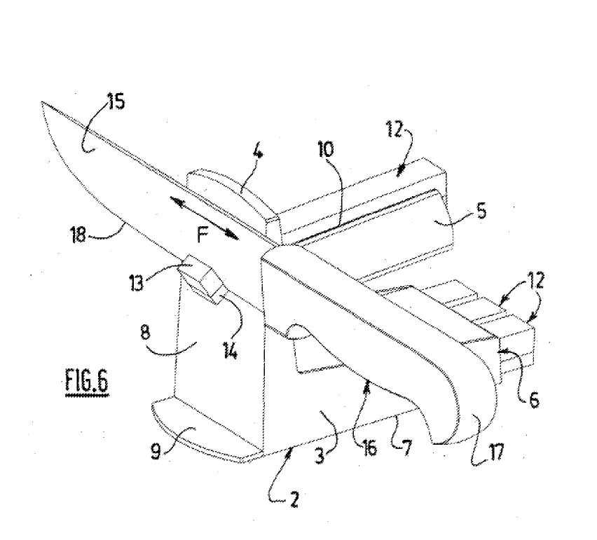

The use of the device described above, for example to test the blade 15 of a knife 16 is illustrated in FIG. 6.

To perform the test, a foam rod 12 is placed in the slide 10, extending by a few millimeters beyond the end of the rod 12 in front of the opening 11, and therefore from the bearing surface 8. It is ensured that the first foam layer 13 of rod 12, i.e. the red layer is located at the top, while the second foam layer 14, green, is then located at the bottom.

The operator then takes the knife 16 in the usual way, by its handle 17, he tries to cut off the end of the bicolor rod 12 which protrudes. For this purpose, he makes alternating back and forth movements, according to the double arrow F, maintaining a cutting pressure as much as possible constant and identical to the one he usually exerts to cut, for example, a piece of meat with the same section, and in the same ergonomic position.

The operator will then see the blade 15 of the knife 16 to be tested cut the foam rod 12 more or less deeply, depending on the cutting quality of the edge 18 of the blade 15. The cutting test itself is then performed:
If the knife 16 cuts correctly, the upper red foam layer 13 is fully severed, and the green lower foam layer 14 appears before the edge 18, as shown in FIG. 6. The knife 16 can thus be evaluated as “satisfactory.”
If, however, the upper foam layer 13 is not severed or is severed only partially, the device reveals the
   red layer at the level of the edge 18 of the blade 15. The knife 16 does not sufficiently cut the foam rod 12 and the knife 16 is thus evaluated as “unsatisfactory.”

The test is thus accomplished in a few back and forth movements of the knife 16 in an almost instantaneous manner.

In a very short time, the operator can, if desired, confirm the result of an initial cutting test by performing a new similar test.

Before a new test, the operator slightly pulls forward the foam rod 12 in the slide 10, so as to have, in front of the bearing surface 8, two or three millimeters of extra foam ready to be cut, and so on, if necessary.

After a cutting test, the foam rod 12 may be either completely severed or partially cut (in the red part only or also in a fraction of the green part) or almost completely sliced, but leaving a think thread of uncut foam, the depth of the cut made being dependent on the cutting ability of the knife 16 being tested. The foam rod 12 is therefore not necessarily separated into two parts after the cutting test itself. For practical reasons, it is preferable that after more or less strongly cutting the foam rod 12, the operator complete the cutting of the foam rod 12 by pressing harder on the blade 15 (this is not equivalent to a test), or by hand pulling the piece of rod that hangs to avoid any interference caused by this piece.

The bearing surface 8 of the shield 4 serves as a guide on the side of the blade 15 of the knife 16 during the cutting test of the latter. The stop 9 is able to stop the blade 15 of the knife 16, if said blade 15 would fully sever the foam rod 12 during the test, thus avoiding scratching or otherwise damaging the work surface on which the device stands. The shield 4 also protects the operator's hand during the test.

The sole 7 of the base 3 allows placing the device on any suitable work surface during the cutting test. This sole 7 can be provided with anti-skid.

It is no departure from the scope of the disclosure as defined in the appended claims, if one changed the forms of the details of the devices, especially the box, which may be made of any suitable material:

steel, stainless steel, aluminum allow, plastic, etc. More specifically, the box can be made with the simplest forms and of an economic material, to form a device intended for single use.

The foam rod may, depending on the intended use of the device, be made with a section more or less large, and in a more or less dense foam, the nature of this foam itself being variable, and the colors the two components of the rod are also variable. The number of visually discernible parts of the foam rod can be greater than two, for example equal to three with an intermediate layer which is orange and which would characterize a borderline, barely acceptable, of the cutting tool tested.

According to its intended use or marketing method, the cutting test device can be presented as a standalone device or as an attachment placed on a device that is automatic or not, or contiguous to it, or associated with a workstation. This machine or this workstation can be either an appliance or post for using cutting tools, such as a food processor or a machine for sharpening cutting tools.

Finally, the cutting test device is suitable for all kinds of sharp tools, for all trades and a variety of venues. Thus, it includes domestic, professional and industrial applications in the food and other industries, for cutting tests of knives, surgical instruments, cutting tools used in agriculture and gardening, industrial cutting tools, craft tools, etc. or as part of the routine use of such tools and instruments, or in the manufacture and maintenance of cutting tools and instruments.

1. Cutting test device for knives and other cutting tools, allowing the cutting ability to be evaluated, the cutting test device comprising:
on the one hand, a rigid body with a slide and a bearing surface substantially perpendicular to the slide and able to position and guide a cutting tool to be tested,
and on the other hand, at least one foam rod designed to be, in use, placed in the aforementioned slide so as to exceed, at one end at the front of the bearing surface, the foam rod having at least two visually discernible overlapping parts.

2. Cutting test device according to claim 1, wherein said rigid body has a base forming a sole, a shield extending upward from the base and defining the aforementioned bearing surface, and a handle attached to the shield and extending above the base, the handle having a longitudinal slide which constitutes the slide adapted to receive a foam rod.

3. Cutting test device according to claim 2, wherein, to receive a foam rod with square or rectangular section, the longitudinal slide of the handle has a corresponding square or rectangular section, and in that the shield has an opening also with corresponding section, arranged in the continuation of the slide mentioned above.

4. Cutting test device according to claim 2, wherein the base is extended by a stop at the base of the shield.

5. Cutting test device according to claim 2, wherein the base has at least one housing in the shape of a honeycomb, suitable for receiving a replacement foam rod.

6. Cutting test device according to claim 1, wherein the foam rod or each foam rod results from the superposition of a first foam layer, which is the top layer when in use, and a second foam layer, which is the lower layer when in use, the two layers being assembled by bonding at their interface.

7. Cutting test device according to claim 6, wherein the height (H) of the upper foam layer is greater than the height (h) of the lower foam layer of the rod.

8. Cutting test device according to claim 7, wherein the height (H) of the upper foam layer accounts for roughly two thirds of the total thickness of the rod, whereas the height (h) of the lower foam layer is substantially one third of the total thickness of the rod.

9. Cutting test device according to claim 6, wherein the two foam layers of the rod are of different color, for example with an upper layer red and a lower layer green.

10. Foam rod having at least two overlapping portions visually discernible, intended for use in a cutting test device according to claim 1.
